(19) United States
(12) Patent Application Publication
(10) Pub. No.: US 2009/0059728 A1
(43) Pub. Date: Mar. 5, 2009

(54) EXPANDABLE USB DATA TERMINAL FOR TIME & ATTENDANCE AND DATA COLLECTION APPLICATIONS

(75) Inventor: Ellery W. Potash, Marietta, GA (US)

Correspondence Address: GEORGE R. REARDON, 3356 STATION COURT, LAWRENCVILLE, GA, 30044, US

(73) Assignee: LATHEM TIME CORPORATION, Atlanta, GA (US)

(21) Appl. No.: 11/845,589

(22) Filed: Aug. 27, 2007

(51) Int. Cl. G04B 47/00

(52) U.S. Cl. 368/10; 235/377

(57) ABSTRACT

A time and attendance device having an integrated USB hub and microcontroller is provided. An automated voice feature is provided that is controlled in response to user parameters. Also provided are a single target area having attention-getting illumination, proximity reader positioning, and transaction status indicators.

This application claims the benefit of U.S. Provisional Application No. 60/88,055, filed Feb. 2, 2007.

### FIELD OF THE INVENTION

The technology described herein relates to the field of time and attendance devices and other data collection devices.

### BACKGROUND OF THE INVENTION

Multiple problems exists with current time and attendance devices.

In most situations data collection terminals, e.g., a time and attendance device, are designed to accomplish a specific task and all components needed to execute those tasks are included within the design. Providing circuitry and connectors for future expansion is often eschewed by the designer, primarily to minimize manufacturing costs. In some situations, the designer will anticipate the need for future expansion but because the nature of the future expansion requirements is unknown at the time the design will be of a general purpose serial or parallel type; often having either more capability than will be ultimately needed, which increases cost, or insufficient capability to suit a future requirement which renders the facility useless for that purpose.

Engineers generally try to anticipate any future expansion needs in order to build and test these accessory options into the product architecture. This approach has two inherent problems:
1. having to predetermine what future expansion options may be required
2. an additional production cost of the standard unit to support the program, memory and physical connection to these options.

When employees utilize a T&A (Time & Attendance) terminal, they are often in a great hurry to either start or terminate their work day. As a result, they are apt to be too abrupt in completing their transactions and not take heed of simple auditory, e.g., beeps, or visual queues, e.g., colored lights, indicating the completion status of the transaction.

This is a particular problem if the intended transaction is rejected by the terminal, but the employee is unaware of this condition. As a result, the transaction is not properly recorded and the employee's time record may be incorrect for proper payroll calculation, or may result in an unjustified tardiness report.

In addition, terminals that rely only upon simple auditory or visual queues may be difficult, inappropriate for, or unusable by, visually impaired personnel.

In T&A and similar data collection terminals designed to read proximity badges, fobs or tokens, it may not be apparent to the user which surface or location of the terminal must be approached with the identity token in order to achieve reliable reading and/or registration. By illuminating the area to be approached by the token, the user is visually drawn to that location and is rewarded with likely success in his/her transaction. By including the visual indicator for transaction acknowledgement or rejection within the same area, the user's attention may be focused on one area of the terminal's face for all activity.

Designers of T&A and other data collection terminals have incorporated coded audio signals, e.g. coded beeps, colored lights, e.g. green for “Yes”; red for “No”, and expensive character and/or graphic displays to provide user information and prompting.

Designers have, for many years, used lighting indicators to indicate the status of equipment operation or transactional status. In T&A terminals incorporating a sub-surface proximity badge reader, they have used contoured shapes, graphical images or written indicia to call attention to the appropriate location on the terminal's face for token placement. None of these solutions have reduced cost and complexity while expanding aesthetic design freedom by integrating these features using controlled, illuminated indicia.

While designers have attempted to anticipate the need for future expansion, because the nature of the future expansion requirements is unknown at the time, the design will be of a general purpose serial or parallel type; often having either more capability than will be ultimately needed (increasing cost), or insufficient capability to suit the future requirement (rendering the facility useless). Designers of all types of automated equipments have sought a low-cost, “universal” connectivity solution to meet requirements of future expandability. Until the advent and popular acceptance of the Universal Serial Bus (USB) interface and protocols, there has been no “universal” interface that could be expanded by non-technical personnel. Until the integration of a USB hub component with a general purpose microcontroller, it would not have been cost effective to include a universal expansion hub as a standard feature.

A further problem is that Time & Attendance Transaction Terminals that are not Battery Operated require two connecting cables, one for power and another for data transmission; or they may require a unique cable that combines the data-carrying wires and the power-carrying wires to be enclosed within a single cable jacket, but which split-out the two functions into separate connectors to mate with standard sources and destinations; as if there were two cable assemblies. Not only does this configuration represent a cost burden to terminal manufacturers and cable installers, but this duplicity of cables creates an unattractive installation of the Terminal upon the table or wall where the terminal is to be installed.

Patents and published patent applications directed to this area include:

U.S. Pat. No. 4,333,085, issued to Witts on Jun. 1, 1982 discloses a data recorder for use in processing cards and the like comprises a housing which has mounted therein electronic control system incorporating both firmware and software programs. A thermal printer and optical reading device are mounted in the housing for printing information onto the card and reading information on the card respectively. The data recorder may be used as a clocking-on device and special cards provided for changing at least one of the software programs of the electronic control system.

U.S. Pat. No. 4,819,162, issued to Webb, Jr. et al. on Apr. 4, 1989, discloses a computerized time clock system which includes a personal computer via which employee, job and schedule records may be assembled and maintained. A computerized time clock communicates with the personal computer and received employee and scheduling data therefrom, in order to validate and record time-in and time-out transactions executed by employees. Current time records are maintained in the memory of the time clock and at the end of each day are transmitted to the personal computer for addition to permanent disk records including a record of each time-in and time-out transaction for an extended period. Sales records may also be maintained in personal computer, for example the quantity of liquor or food served by a particular employee or in a particular department, which sales information may be correlated with labor costs found in the permanent time records.

U.S. published patent application 2002/0175211, inventor Dominquez et al. published on Nov. 28, 2002, discloses a time and attendance system and method are provided for monitoring employees at remote worksites such as construction sites. The system comprises one or more portable recording apparatuses. Each of these portable recording apparatuses includes means for identifying its geographical location, a keypad for the employees' entry of an ID upon clocking into or out of a worksite and a digital camera for capturing a visual image of the employees upon each such event. The recording apparatus captures and stores these data on a local database in association with the employees' IDs. The recording apparatus periodically establishes contact, over the Internet or another network, with a central computer to transmit the stored information, including the recording apparatus's geographical location, to the central computer. The central computer stores reference visual images for the employees. Using a computer connected to the network, an authorized user can access the central computer at any time to verify attendance at the worksite including comparing the visual images captured by the recording apparatus for the employees with their reference visual images.

U.S. Published Patent Applications 2006/0146649, inventor Pappas et al. published on Jul. 6, 2006, discloses a time attendance system, including a time attendance clock, designed to be used in harsh conditions, such as outdoor job sites. A portable touch button, including a passively readable code, is brought into contact with the time attendance clock so as to create a time attendance record stored in the clock. Visual indicators and audible notification alert the employee of the acceptance of the act. Periodically, the time attendance records are retrieved from the time attendance clock, such as by using a hand-held electronic device which communicates in a wireless manner with the time attendance clock.

While these patents, published patent applications and other previous methods have attempted to solve the problems that they addressed, none have utilized or disclosed an integrated USB hub and microcontroller, as does embodiments of the technology described herein.

Therefore, a need exists for a solution to the above problems. The attributes and functionalities of technology described herein provide this solution. The expandable USB data terminal for time & attendance and data collection applications device according to embodiments of the invention substantially departs from the conventional concepts and designs of the prior art. It can be appreciated that there exists a continuing need for a new and improved expandable USB data terminal for time & attendance and data collection applications device which can be used commercially. In this regard, the technology described herein substantially fulfills these objectives.

The foregoing information reflects the state of the art of which the inventor is aware and is tendered with a view toward discharging the inventor's acknowledged duty of candor in disclosing information that may be pertinent to the patentability of the technology described herein. It is respectfully stipulated, however, that the foregoing information do not teach or render obvious, singly or when considered in combination, the inventor's claimed invention.

### BRIEF SUMMARY OF THE INVENTION

The general purpose of the technology described herein, which will be described subsequently in greater detail, is to provide an expandable USB data terminal. In particular, the technology described herein relates to an expandable USB data terminal for time & attendance and data collection applications.

There are several aspects to the technology described herein, which may be utilized separately, or in combination.

The technology described herein employs an integrated USB hub to provide a low-cost, universal means of feature expansion that may be field-enhanced without the need for special skills or tools.

The technology described herein employs a difficult-to-ignore automated voice that is controlled in response to the parameters of the user's transaction. This feature allows the technology described herein to be easilly used by persons with visual impairment.

By integrating attention-getting illumination, proximity reader positioning, and transaction status indicators within a single “target” area, manufacturing costs may be reduced while facilitating use of these multiple user-interface features.

By incorporating a USB hub within the technology described herein, of the type currently integrated with a general-purpose microcontroller for executing basic terminal functions, a universal facility for simple expansion of terminal functionality is provided that is low in cost and suitible for field upgrade by non-technical personnel. The technology described herein provides a method of time clock expandability that is superior to current implementations (typically a device is built and developed around all of the features it is intended to provide).

The design of the technology described herein addresses issues with current devices by utilizing standard pass-through USB ports that can connect virtually any USB peripheral. No forethought needs to be given to the program requirements. Also, unlike the myriad of different hardware connections that may be needed for different devices, the design of the current technology described herein includes a simple, low cost USB interface. The design of the current technology described herein puts peripherals at the location where employees will be clocking in and out; whereas, typically, they would be nearby a host computer. This feature has inherent benefits when adding employee-centric devices such as fingerprint sensors, cameras, printers, etc.

In an embodiment of the technology described herein inclusion of a voice synthesis or controlled voice play-back system to provide users of the terminal with operational prompting, status messages, or activity instructions based upon the user's presentation at the terminal:
1. provides an additional and immediate transactional response that may not be as easilly ignored as simple auditory or visual queues
2. enables visually impaired users to more fully interact with the terminal's functions

By integrating a USB hub within a USB-interfaced data terminal, the USB-interfaced data terminal's functionality can be simply expanded through the attachment of standard USB-compatible devices that are complimentary to the mission of the product. For example, a Time & Attendance terminal having a proximity badge reader as a basic, internal component can be quickly expanded, without the need for special tools, technical ability on the part of the installer, or enclosure alteration, by attaching a biometric/fingerprint reader, camera, microphone, or similar validation component through its down-stream USB interface.

In one embodiment of the technology described herein a Time & Attendance Transaction Terminal that incorporates a Badge/Token Reader and a Character display capable of showing Alpha and/or Numeric Characters/Digits is connected either to a Host Computer or through a Hub accoriding to the USB Connectivity Specification, and which derives its operating power from the Host Computer or a USB Hub through the USB Cable. The single USB Cable carries both transaction data and operating power for the Terminal, and relieves the requirement of having batteries or a separate source cable to bring operating power to the Terminal.

In one embodiment of the technology described herein unique and/or personalized individual spoken messages may be played to each employee based on the following criteria.
1. The transaction being an IN or OUT transaction, e.g. “hello”, “goodbye”
2. The time of day of the transaction, e.g. “good morning”, “good evening”
3. The date of the transaction, e.g. “happy birthday”, “congratulations on your anniversary”
4. Actual time versus scheduled time transaction, “you are late”, “you are leaving early”

In one embodiment of the technology described herein users, e.g. managers or supervisors, may record custom audio messages to each employee versus standard canned audio messages, e.g. “Joe, please report to shipping”.

In one embodiment of the technology described herein text to speech technology is utilized to play relevant real-time audio updates to employees, e.g. “You have worked 35 hours.”

An aspect of the technology described herein is the inclusion of a voice synthesis or controlled play-back system to provide users of the Time & Attendance terminal with operational prompting, status messages, or activity instructions based upon the user's presentation at the Time & Attendance terminal.

Another aspect of the technology described herein is the positioning of controlled illumination, visible from the exterior of the time & attendance terminal, which will direct the user's attention to the area behind which a Proximity Badge/Fob Reader is positioned to read the users identity token. The colors of illumination may change to further indicate the status of the transaction being executed, e.g, from a normal color e.g. white or blue, to green for acknowledge, or red for failure.

Another aspect of the technology described herein is customized audio messaging capability.

These and other features and advantages of the technology described herein will be presented in more detail in the following specification of the invention and the accompanying Figures, which illustrate by way of example the principles of the invention.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the technology described herein. It is important, therefore, that the claims be regarded as including such equivalent constructions insofar as they do not depart from the spirit and scope of the technology described herein.

### BRIEF DESCRIPTION OF THE SEVERAL VIEWS OF THE DRAWINGS

The invention, together with further advantages thereof, may best be understood by reference to the following description taken in conjunction with the accompanying drawings in which:

FIG. 1 illustrates an integrated USB hub and micro controller arrangement, according to an embodiment of the technology described herein.

FIG. 2 illustrates detail of a voice synthesis/voice play back arrangement, according to an embodiment of the technology described herein.

FIG. 3 illustrates a proximity reader indicators arrangement according to an embodiment of the technology described herein.

FIG. 4 illustrates a proximity reader module, according to another embodiment of the technology described herein.

FIG. 5 illustrates positioning of lighting indicators above a sub-surface proximity antenna, according to an embodiment of the technology described herein.

### DETAILED DESCRIPTION OF THE INVENTION

The technology described herein will now be described in detail with reference to a few preferred embodiments thereof as illustrated in the accompanying drawings. In the following description, numerous specific details are set forth in order to provide a thorough understanding of the technology described herein. It will be apparent, however, to one skilled in the art, that the technology described herein may be practiced without some or all of these specific details. In other instances, well known operations have not been described in detail so not to unnecessarily obscure the technology described herein.

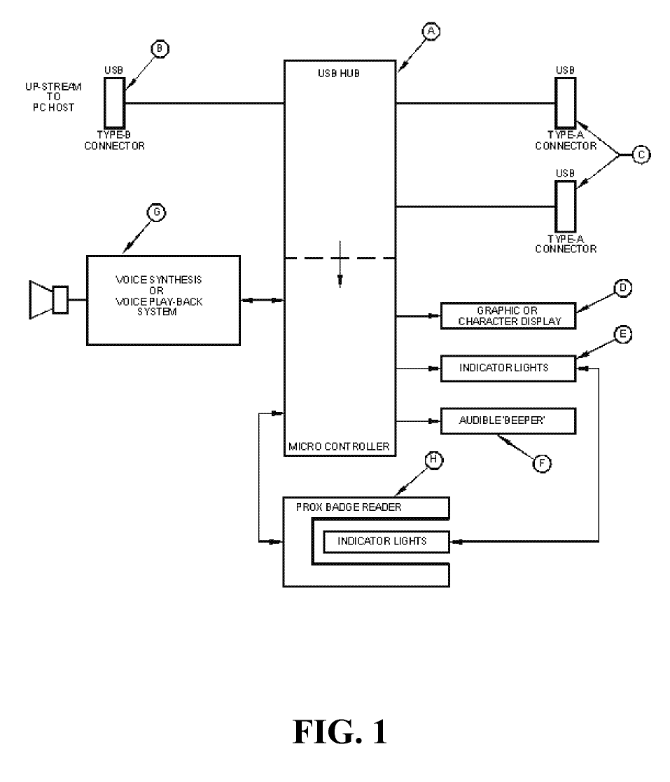

Referring now to FIG. 1 through FIG. 5 as part of the data collection terminal, a controlling microprocessor/microcontroller is integrated with a USB hub to provide a simple and low-cost means of future functional expansion through the attachment of functionally related peripheral devices. A currently available component that fulfills this requirement is the Texas Instruments TUSB2136, which integrates an 8052-type microcontroller with a USB hub onto a single IC (Integrated Circuit).

Voice synthesis or play-back would typically require a sufficient amount of storage memory (ex: Microchip 27LC1025 Serial EEPROM) for the digitized voice pattern; a digital-to-analog converter (typically Texas Instruments DAC5571) to convert the stored digital voice pattern for analog play-back; an audio amplifier (typically Motorola/Freescale MC34119) to boost the signal power; a (digital) potentiometer (typically analog devices AD5246) to regulate the volume; and an audio transducer (speaker) to produce the sound. In cases where data throughput from the Host PC to the Terminal is sufficient to sustain acceptable voice rendition (typically on the order of 6,000 samples per second), it is possible to eliminate the costly storage memory component in favor of streaming the audio codes directly from the Host PC to the DAC, under control of the Terminal's Firmware.

Using standard drivers for controlled illumination, colored LEDs (Light Emitting Diodes), or other mineature lighting products are positioned within or adjascent to the antenna area of the terminal's proximity reader. Implementation of the multi-colored indicator may be achieved using multiple, discrete, LEDs/Lights of red, green, blue, white, etc., or may utilize an integrated display element capable of rendering a multitude of colors. Sequencing of the lighting devices, under automated control, can signal positive or negative responses, or prompting indications.

The main component of the design is an integrated USB Hub and microcontroller (FIG. 1, Part-A). The up-stream port of the USB Hub (FIG. 1, Part-B) is, typically, connected to a host computer that executes the program to control the terminal's operation. The down-stream ports of the Hub (FIG. 1, Part-C) are made available with standard Type-A connectors to support universal attachment of USB-compatible peripherals. The microcontroller portion of the integrated device functions as a USB device; that it may receive commands from the up-stream USB port (FIG. 1, Part-A) and communicate status and data to the host computer through that port. Through the execution of firmware instructions by the microcontroller (as directed by the host computer), the terminal may display graphic or textual messages upon a display device (FIG. 1, Part-D), provide propmting and/or status information through the controlled illumination of lighting indicators (ex: LED's) (FIG. 1, Part-E). or may provide audible tones (ex: 1 “beep” for “Yes”/2 ‘beeps’ for “No”) through a tone device (ex: Piezo Beeper) (FIG. 1, Part-F); or through an audio system (FIG. 1, Part-G). Using a synchronous serial interface (typically I2C or SCI protocol), the microcontroller would interface a voice synthesis or voice play-back system (FIG. 1, Part-G).

Using a serial (typically asynchronous Serial TTL, RS-232 or RS-485), or parallel, e.g. WEIGAND type, the microcontroller interfaces with a priximity badge reader module (FIG. 1, Part-H) which may be on a separate mounting platform within the enclosure, or which may be integrated onto the same circuit board as the Hub/Controller (FIG. 1, Part-A). Execution of the Terminal's mission is controlled by Firmware (Program Code) which may be non-volatile resident within the Controller's Memory section, or which may be down-loaded into the Terminal from the Host Computer. Specific Commands to be executed, during the processing of User Transactions, are to be provided by Software executing within the Host Computer.

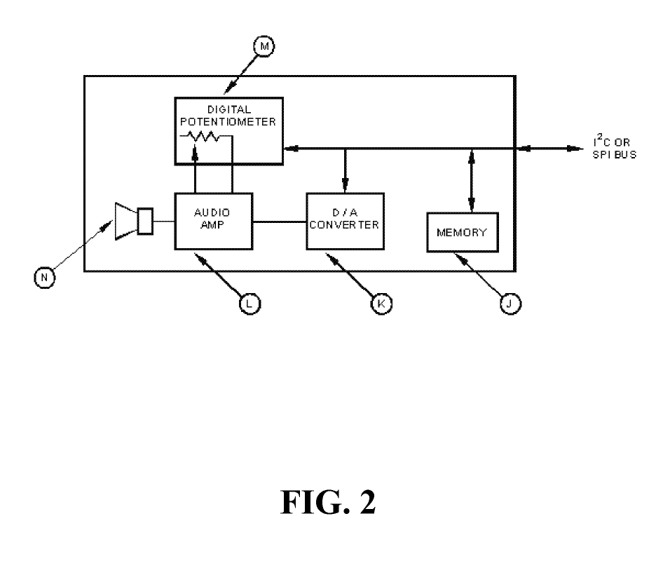

The Voice Synthesis/Voice Play-Back System is composed of a Memory Module (FIG. 2, Part-J) which can hold either the digitized audio signal sequence necessary to play a recorded sound, or a Code Sequence (such as the plain text of the words to be spoken) which would be synthesized by MicroController Firmware execution. A Digital-to-Analog Converter (FIG. 2, Part-K) would receive the data stream representative of the voice or sounds to play, and convert that data into weak analog voltages/currents representative of the desired audio signal. In cases where data throughput from the Host PC to the Terminal is sufficient to sustain acceptable voice rendition (typically on the order of 6,000 samples per second), it is possible to eliminate the costly storage memory component in favor of streaming the audio codes directly from the Host PC to the DAC, under control of the Terminal's Firmware. An Audio Amplifier (FIG. 2, Part-L) receives the weak analog signal and amplifies it (providing sufficient voltage/current) to drive the end-stage Audio Transducer (typically a Paper, Mylar or Piezo Speaker) (FIG. 2, Part-N).

To provide a means by which the user can adjust the audio volume of the sound, a Potentiometer is provided (typically at the Amplifier's Input, to attenuate; or in its feed-back loop, to control the Amplifier's gain). The Potentiometer (“Pot”) may be a knob-adjusted Analog type (allowing direct user control), or may be a Digital type (FIG. 2, Part-M) allowing control via Host Command, through the MicroController (FIG. 1, Part-A).

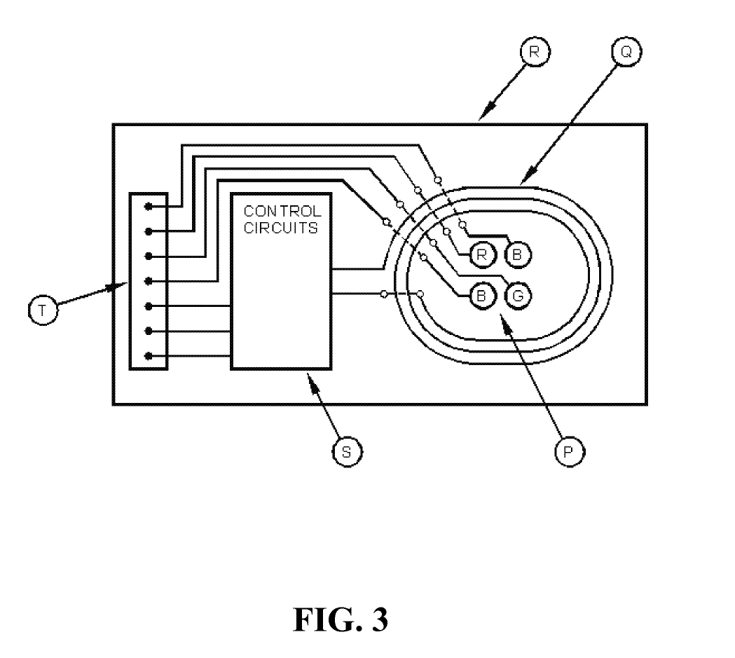

The unique user interface presentation provided by the technology described herein is achieved through placement of illuminating indicators (FIG. 3, Part-P), capable of rendering white, blue, red or green indication, within the center of the Proximity Reader's Antenna Loop (FIG. 3, Part-Q), or closely adjascent to the Antenna. The Antenna Loop is, typically, mounted onto a PC Board (FIG. 3, Part-R) that includes the Prox Reader Control Circuitry (FIG. 3, Part-S) and, if this assembly be on a separate Module, a Connector (FIG. 3, Part-T) routing control signals to the MicroController (FIG. 1, Part-A). In one embodiment of the technology described herein, the colored indicators (LEDs) are mounted upon the same circuit board as is the Prox Reader System, as shown in FIG. 3.

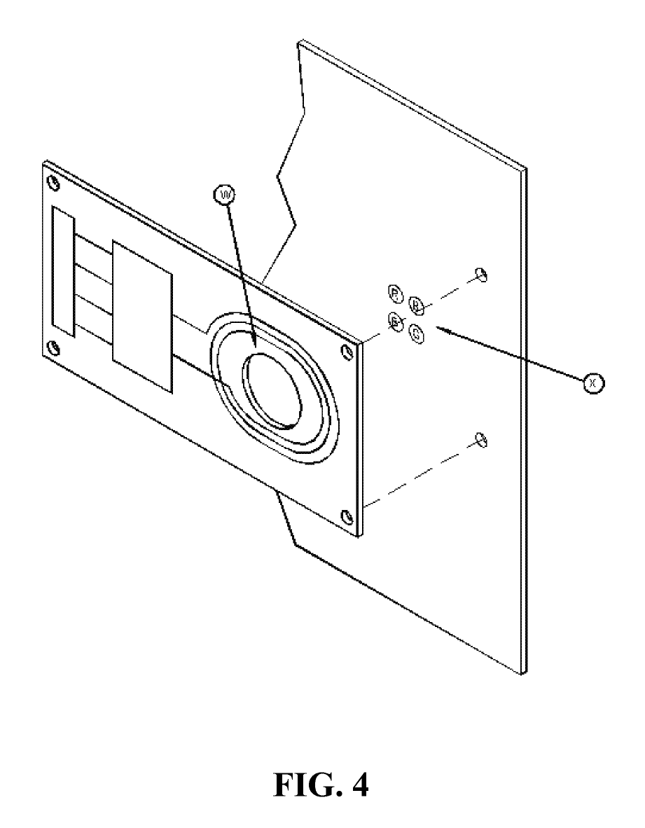

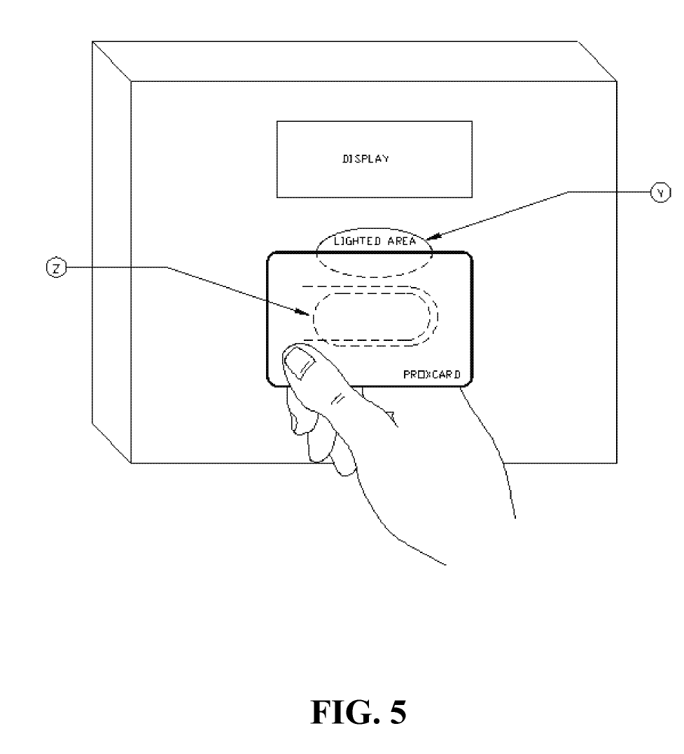

In another embodiment of the technology described herein, an opening may be fabricated within the center of the Antenna Loop (FIG. 4, Part-W), and the Prox Reader Module would be situated over the MicroController Circuit Board in such a position so as to permit LEDs mounted on the Controller Board (FIG. 4, Part-X) to be visible through the opening. A third implementation would place the lighting indicators on the main Circuit Board, positioned directly above the Antenna Loop. This is simple, cost effective and appropriate as, when the Proximiaty Badge is held by hand in a comfortable position, touching the angled card-edge to the lighted area (FIG. 5, part-Y) would place the Badge's internal Antenna in a position nearly parallel with the Prox Reader's sub-surface Antenna (FIG. 5, part-Z), to achieve optimum readability.

In one embodiment of the technology described herein, the device comprises a universal serial bus hub, an upstream port located on the universal serial bus hub and configured for connectivity to a host computer that executes a program to control the device for time and attendance and data collection applications, a plurality of downstream ports located on the universal serial bus hub and configured for connectivity to a plurality of universal serial bus peripherals and to provide expandability to the expandable universal serial bus data terminal device and a microcontroller configured to process commands received at the upstream port, communicate both status and data information with the host computer through upstream port connectivity, and communicate status, time, and attendance information to a user of the expandable universal serial bus data terminal device.

The universal serial bus hub and the microcontroller may be integrally formed within the expandable universal serial bus data terminal device.

The device may also have a proximity badge reader module and integrated antenna loop, located on or within the expandable universal serial bus data terminal device and interfaced with the microcontroller, configured to receive input communications from a plurality of users each bearing a unique badge, fob, or token and to communicate with the microcontroller. Additionally the universal serial bus hub, the microcontroller, and the proximity badge reader may be integrally formed within the expandable universal serial bus data terminal device.

The device may also have a graphical display module, located on the device and interfaced with the microcontroller, configured to receive graphical display information from the host computer through the microcontroller and to conspicuously present the graphical display information to a user of the device.

The device may also have a character display module, located on the device and interfaced with the microcontroller, configured to receive textual display information from the host computer through the microcontroller and to conspicuously present the textual display information to a user of the device.

The device may also have a plurality of indicator lights, located on the expandable universal serial bus data terminal device and interfaced with the microcontroller, to receive instructions from the microcontroller and conspicuously provide prompting and status information to a user through controlled illumination of the plurality of indicator lights.

The plurality of indicator lights may be comprised of light emitting diodes where the sequencing of the lighting and the varied illuminated colors of the light emitting diodes provide prompting and status information to a user through controlled illumination of the light emitting diodes. Additionally the plurality of indicator lights to provide prompting and status information to a user may be strategically positioned at a most desirable area of contact for the user's proximity badge, fob, or token, within or immediately adjacent to the terminal's receiving loop antenna; thereby focusing the user's attention toward a single location on the face of the terminal while increasing the likelihood of a successful transaction.

The device may be further comprised of a tone element, located within the device and interfaced with the microcontroller, to receive instructions from the microcontroller and provide prompting and status information to a user through controlled audio tone activation of the tone element. This tone element may be a Piezo beeper.

The device may be further comprised of a voice synthesis module or a voice playback module, interfaced with the microcontroller, to receive instructions from the microcontroller and provide audible prompting and status information to a user where the prompting and status information of the voice synthesis module is one or more of a controlled, synthesized voice message; and where the prompting and status information of the voice playback module is one or more of a controlled, recorded voice message. Additionally, the device may be further comprised of a memory module configured to store a digitized audio sequence for the voice playback module to play a recorded message or to store a code sequence of a plurality of words for the voice synthesis module to be synthesized and synthetically spoken, a digital-to-analog converter to receive a data stream of information to be played in a recorded message or to be synthesized and synthetically spoken and to convert the data stream into an analog audio signal, an audio transducer through which a message from the voice playback module or the voice synthesis module is broadcast and a user of the expandable universal serial bus data terminal device hears the message; and an audio amplifier to amplify the analog audio signal for the audio transducer. Also, the device may be further comprised of a potentiometer to control a gain of the audio amplifier, providing the user of the expandable universal serial bus data terminal device a means to directly control the volume of the audio amplifier or providing an operator at the host computer a means to directly control the volume of the audio amplifier.

In the technology described herein the upstream port located on the universal serial bus hub may be comprised of a Type-B, Mini-B, or Micro-AB universal serial bus connector.

In the technology described herein each of the plurality of downstream ports located on the universal serial bus hub may be comprised of a Type-A or Micro-AB universal serial bus connector.

The technology described herein may be further comprised of a single universal serial bus cable, located between the expandable universal serial bus data terminal device and either the host computer or a universal serial bus hub to which it is connected, to provide both a data transfer path and power to the expandable universal serial bus data terminal device.

In yet another embodiment of the technology disclosed herein a data terminal device for time and attendance and data collection applications whose external connections utilize wired or wireless communication protocols defined by the IEEE 802.xx family of specifications, comprises:
an Ethernet interface with a MAC Layer and wired or wireless physical layer;
a port located on the terminal and configured for connectivity to a host computer that executes a program to control the data terminal device for time and attendance and data collection applications;
a microcontroller configured to process commands received at the upstream port, communicate both status and data information with the host computer through upstream port connectivity, and communicate status, time, and attendance information to a user of the expandable universal serial bus data terminal device;
a voice synthesis module or a voice playback module, located on the expandable universal serial bus data terminal device and interfaced with the microcontroller, to receive instructions from the microcontroller and provide prompting and status information to a user; where the prompting and status information of the voice synthesis module is one or more of a controlled, synthesized voice message and where the prompting and status information of the voice playback module is one or more of a controlled, recorded voice message;
a memory module configured to store a digitized audio sequence for the voice playback module to play a recorded message and to store a code sequence of a plurality of words for the voice synthesis module to be synthesized and synthetically spoken;
a digital-to-analog converter to receive a data stream of information to be played in a recorded message or to be synthesized and synthetically spoken and to convert the data stream into an analog audio signal;
an audio transducer through which a message from the voice playback module or the voice synthesis module is broadcast and a user of the expandable universal serial bus data terminal device hears the message; an audio amplifier to amplify the analog audio signal for the audio transducer; and
a potentiometer to control a gain of the audio amplifier, providing the user of the expandable universal serial bus data terminal device a means to directly control the volume of the audio amplifier and providing an operator at the host computer a means to directly control the volume of the audio amplifier.

A method for time clock expandability for time and attendance and data collection applications is comprised of:
utilizing an expandable universal serial bus data terminal;
providing time clock expandability to a universal serial bus data terminal;
utilizing a universal serial bus hub;
utilizing an upstream port located on the universal serial bus hub and configuring the upstream port for connectivity to a host computer, the host computer executing a program for controlling the expandable universal serial bus data terminal device for time and attendance and data collection applications;
utilizing a plurality of downstream ports located on the universal serial bus hub, configuring the plurality of downstream ports for connectivity to a plurality of universal serial bus peripherals, and providing expandability to the expandable universal serial bus data terminal device; and
utilizing a microcontroller configured for processing commands received at the upstream port, communicating both status and data information with the host computer through upstream port connectivity, and communicating status, time, and attendance information to the user of the expandable universal serial bus data terminal device.

This method may be further comprised of:
utilizing a proximity badge reader module and integrated antenna loop, located on or within the expandable universal serial bus data terminal device and interfaced with the microcontroller, configuring the proximity badge reader to receive input communications from a plurality of users each bearing a unique badge, fob, or token and to communicate with the microcontroller, or
utilizing a graphical display module, located on the expandable universal serial bus data terminal device and interfaced with the microcontroller, configuring the graphical display module to receive graphical display information from the host computer through the microcontroller, and conspicuously presenting the graphical display information to a user of the expandable universal serial bus data terminal device, or
utilizing a character display module, located on the expandable universal serial bus data terminal device and interfaced with the microcontroller, configuring the character display module to receive textual display information from the host computer through the microcontroller, and conspicuously presenting the textual display information to a user of the expandable universal serial bus data terminal device, or
utilizing a plurality of indicator lights, located on the expandable universal serial bus data terminal device and interfaced with the microcontroller, for receiving instructions from the microcontroller and conspicuously providing prompting and status information to a user through controlling the illumination of the plurality of indicator lights, where the plurality of indicator lights to provide prompting and status information to a user may be strategically positioned at a most desirable area of contact for the user's proximity badge, fob or token, within or immediately adjacent to the terminal's receiving loop antenna; thereby focusing the user's attention toward a single location on the face of the terminal while increasing the likelihood of a successful transaction, or
utilizing a tone device, located within the expandable universal serial bus data terminal device and interfaced with the microcontroller, for receiving instructions from the microcontroller and providing prompting and status information to a user through controlling audio tone activation of the tone device or utilizing a voice synthesis module or a voice playback module, located on the expandable universal serial bus data terminal device and interfaced with the microcontroller, for receiving instructions from the microcontroller and providing prompting and status information to a user where the prompting and status information of the voice synthesis module is one or more of a controlled, synthesized voice message; and where the prompting and status information of the voice playback module is one or more of a controlled, recorded voice message, or
utilizing a memory module configured for storing a digitized audio sequence for the voice playback module for playing a recorded message or for storing a code sequence of a plurality of words for the voice synthesis module for synthesizing and synthetically speaking; utilizing a digital-to-analog converter for receiving a data stream of information, playing the data stream in a recorded message or synthesizing and synthetically speaking and converting the data stream into an analog audio signal; utilizing an audio transducer for broadcasting a message from the voice playback module or the voice synthesis module and at a sufficient volume for a user of the expandable universal serial bus data terminal device hearing the message; and utilizing an audio amplifier for amplifying the analog audio signal for the audio transducer, or
utilizing a potentiometer for controlling a gain of the audio amplifier, providing the user of the expandable universal serial bus data terminal device a means to directly control the volume of the audio amplifier, or providing an operator at the host computer a means to directly control the volume of the audio amplifier, or
utilizing a single universal serial bus cable, located between the expandable universal serial bus data terminal device and either the host computer or a universal serial bus hub to which it is connected, providing both a data transfer path and power to the expandable universal serial bus data terminal device.

From the foregoing, it will be appreciated that, although specific embodiments of the invention have been described herein for purposes of illustration, various modifications may be made without deviating from the spirit and scope of the invention. For example, many of the features and components described above in the context of a particular expandable USB data terminal for time & attendance and data collection applications configuration can be incorporated into other configurations in accordance with other embodiments of the invention. Accordingly, the invention is not limited except by the appended claims.

What is claimed is:

1. An expandable universal serial bus data terminal device for time and attendance and data collection applications, the device comprising:
a universal serial bus hub;
an upstream port located on the universal serial bus hub and configured for connectivity to a host computer that executes a program to control the expandable universal serial bus data terminal device for time and attendance and data collection applications;
a plurality of downstream ports located on the universal serial bus hub and configured for connectivity to a plurality of universal serial bus peripherals and to provide expandability to the expandable universal serial bus data terminal device; and
a microcontroller configured to process commands received at the upstream port, communicate both status and data information with the host computer through upstream port connectivity, and communicate status, time, and attendance information to a user of the expandable universal serial bus data terminal device.

2. The expandable universal serial bus data terminal device for time and attendance and data collection applications of claim 1, wherein the universal serial bus hub and the microcontroller are integrally formed within the expandable universal serial bus data terminal device.

3. The expandable universal serial bus data terminal device for time and attendance and data collection applications of claim 1, further comprising:
a proximity badge reader module and integrated antenna loop, located on or within the expandable universal serial bus data terminal device and interfaced with the microcontroller, configured to receive input communications from a plurality of users each bearing a unique badge, fob, or token and to communicate with the microcontroller.

4. The expandable universal serial bus data terminal device for time and attendance and data collection applications of claim 3, wherein the universal serial bus hub, the microcontroller, and the proximity badge reader are integrally formed within the expandable universal serial bus data terminal device.

5. The expandable universal serial bus data terminal device for time and attendance and data collection applications of claim 1, further comprising:
a graphical display module, located on the expandable universal serial bus data terminal device and interfaced with the microcontroller, configured to receive graphical display information from the host computer through the microcontroller and to conspicuously present the graphical display information to a user of the expandable universal serial bus data terminal device.

6. The expandable universal serial bus data terminal device for time and attendance and data collection applications of claim 1, further comprising:
a character display module, located on the expandable universal serial bus data terminal device and interfaced with the microcontroller, configured to receive textual display information from the host computer through the microcontroller and to conspicuously present the textual display information to a user of the expandable universal serial bus data terminal device.

7. The expandable universal serial bus data terminal device for time and attendance and data collection applications of claim 1, further comprising:
a plurality of indicator lights, located on the expandable universal serial bus data terminal device and interfaced with the microcontroller, to receive instructions from the microcontroller and conspicuously provide prompting and status information to a user through controlled illumination of the plurality of indicator lights.

8. The expandable universal serial bus data terminal device for time and attendance and data collection applications of claim 7, wherein the plurality of indicator lights comprises light emitting diodes and wherein the sequencing of the lighting and the varied illuminated colors of the light emitting diodes provide prompting and status information to a user through controlled illumination of the light emitting diodes.

9. The expandable universal serial bus data terminal device for time and attendance and data collection applications of claim 7, wherein the plurality of indicator lights to provide prompting and status information to a user are strategically positioned at a most desirable area of contact for the user's proximity badge, fob, or token, within or immediately adjacent to the terminal's receiving loop antenna; thereby focusing the user's attention toward a single location on the face of the terminal while increasing the likelihood of a successful transaction.

10. The expandable universal serial bus data terminal device for time and attendance and data collection applications of claim 1, further comprising:
a tone device, located within the expandable universal serial bus data terminal device and interfaced with the microcontroller, to receive instructions from the microcontroller and provide prompting and status information to a user through controlled audio tone activation of the tone device.

11. The expandable universal serial bus data terminal device for time and attendance and data collection applications of claim 9, wherein the tone device comprises a Piezo beeper.

12. The expandable universal serial bus data terminal device for time and attendance and data collection applications of claim 1, further comprising:
a voice synthesis module or a voice playback module, interfaced with the microcontroller, to receive instructions from the microcontroller and provide audible prompting and status information to a user;
wherein the prompting and status information of the voice synthesis module is one or more of a controlled, synthesized voice message; and
wherein the prompting and status information of the voice playback module is one or more of a controlled, recorded voice message.

13. The expandable universal serial bus data terminal device for time and attendance and data collection applications of claim 11, further comprising:
a memory module configured to store a digitized audio sequence for the voice playback module to play a recorded message or to store a code sequence of a plurality of words for the voice synthesis module to be synthesized and synthetically spoken;
a digital-to-analog converter to receive a data stream of information to be played in a recorded message or to be synthesized and synthetically spoken and to convert the data stream into an analog audio signal;
an audio transducer through which a message from the voice playback module or the voice synthesis module is broadcast and a user of the expandable universal serial bus data terminal device hears the message; and
an audio amplifier to amplify the analog audio signal for the audio transducer.

14. The expandable universal serial bus data terminal device for time and attendance and data collection applications of claim 12, further comprising:
a potentiometer to control a gain of the audio amplifier, providing the user of the expandable universal serial bus data terminal device a means to directly control the volume of the audio amplifier or providing an operator at the host computer a means to directly control the volume of the audio amplifier.

15. The expandable universal serial bus data terminal device for time and attendance and data collection applications of claim 1, wherein the upstream port located on the universal serial bus hub comprises a Type-B, Mini-B, or Micro-AB universal serial bus connector.

16. The expandable universal serial bus data terminal device for time and attendance and data collection applications of claim 1, wherein each of the plurality of downstream ports located on the universal serial bus hub comprises a Type-A or Micro-AB universal serial bus connector.

17. The expandable universal serial bus data terminal device for time and attendance and data collection applications of claim 1, further comprising:
a single universal serial bus cable, located between the expandable universal serial bus data terminal device and either the host computer or a universal serial bus hub to which it is connected, to provide both a data transfer path and power to the expandable universal serial bus data terminal device.

18. A method for time clock expandability for time and attendance and data collection applications, the method comprising:
utilizing an expandable universal serial bus data terminal;
providing time clock expandability to a universal serial bus data terminal;
utilizing a universal serial bus hub;
utilizing an upstream port located on the universal serial bus hub and configuring the upstream port for connectivity to a host computer, the host computer executing a program for controlling the expandable universal serial bus data terminal device for time and attendance and data collection applications;
utilizing a plurality of downstream ports located on the universal serial bus hub, configuring the plurality of downstream ports for connectivity to a plurality of universal serial bus peripherals, and providing expandability to the expandable universal serial bus data terminal device; and
utilizing a microcontroller configured for processing commands received at the upstream port, communicating both status and data information with the host computer through upstream port connectivity, and communicating status, time, and attendance information to the user of the expandable universal serial bus data terminal device.

19. The method for time clock expandability for time and attendance and data collection applications of claim 18, further comprising:
utilizing a proximity badge reader module and integrated antenna loop, located on or within the expandable universal serial bus data terminal device and interfaced with the microcontroller, configuring the proximity badge reader to receive input communications from a plurality of users each bearing a unique badge, fob, or token and to communicate with the microcontroller.

20. The method for time clock expandability for time and attendance and data collection applications of claim 18, further comprising:
utilizing a graphical display module, located on the expandable universal serial bus data terminal device and interfaced with the microcontroller, configuring the graphical display module to receive graphical display information from the host computer through the microcontroller, and conspicuously presenting the graphical display information to a user of the expandable universal serial bus data terminal device.

21. The method for time clock expandability for time and attendance and data collection applications of claim 18, further comprising:
utilizing a character display module, located on the expandable universal serial bus data terminal device and interfaced with the microcontroller, configuring the character display module to receive textual display information from the host computer through the microcontroller, and conspicuously presenting the textual display information to a user of the expandable universal serial bus data terminal device.

22. The method for time clock expandability for time and attendance and data collection applications of claim 18, further comprising:
utilizing a plurality of indicator lights, located on the expandable universal serial bus data terminal device and interfaced with the microcontroller, for receiving instructions from the microcontroller and conspicuously providing prompting and status information to a user through controlling the illumination of the plurality of indicator lights.

23. The method for time clock expandability for time and attendance and data collection applications of claim 18, wherein the plurality of indicator lights to provide prompting and status information to a user are strategically positioned at a most desirable area of contact for the user's proximity badge, fob or token, within or immediately adjacent to the terminal's receiving loop antenna; thereby focusing the user's attention toward a single location on the face of the terminal while increasing the likelihood of a successful transaction.

24. The method for time clock expandability for time and attendance and data collection applications of claim 18, further comprising:
utilizing a tone device, located within the expandable universal serial bus data terminal device and interfaced with the microcontroller, for receiving instructions from the microcontroller and providing prompting and status information to a user through controlling audio tone activation of the tone device.

25. The method for time clock expandability for time and attendance and data collection applications of claim 18, further comprising:
utilizing a voice synthesis module or a voice playback module, located on the expandable universal serial bus data terminal device and interfaced with the microcontroller, for receiving instructions from the microcontroller and providing prompting and status information to a user;
wherein the prompting and status information of the voice synthesis module is one or more of a controlled, synthesized voice message; and
wherein the prompting and status information of the voice playback module is one or more of a controlled, recorded voice message.

26. The method for time clock expandability for time and attendance and data collection applications of claim 18, further comprising:
utilizing a memory module configured for storing a digitized audio sequence for the voice playback module for playing a recorded message or for storing a code sequence of a plurality of words for the voice synthesis module for synthesizing and synthetically speaking;
utilizing a digital-to-analog converter for receiving a data stream of information, playing the data stream in a recorded message or synthesizing and synthetically speaking and converting the data stream into an analog audio signal;
utilizing an audio transducer for broadcasting a message from the voice playback module or the voice synthesis module and at a sufficient volume for a user of the expandable universal serial bus data terminal device hearing the message; and
utilizing an audio amplifier for amplifying the analog audio signal for the audio transducer.

27. The method for time clock expandability for time and attendance and data collection applications of claim 18, further comprising:
utilizing a potentiometer for controlling a gain of the audio amplifier, providing the user of the expandable universal serial bus data terminal device a means to directly control the volume of the audio amplifier, or providing an operator at the host computer a means to directly control the volume of the audio amplifier.

28. The method for time clock expandability for time and attendance and data collection applications of claim 18, further comprising:
utilizing a single universal serial bus cable, located between the expandable universal serial bus data terminal device and either the host computer or a universal serial bus hub to which it is connected, providing both a data transfer path and power to the expandable universal serial bus data terminal device.

29. A data terminal device for time and attendance and data collection applications whose external connections utilize wired or wireless communication protocols defined by the IEEE 802.xx family of specifications, the device comprising:
an Ethernet interface with a MAC Layer and wired or wireless physical layer;
a port located on the terminal and configured for connectivity to a host computer that executes a program to control the data terminal device for time and attendance and data collection applications;
a microcontroller configured to process commands received at the upstream port, communicate both status and data information with the host computer through upstream port connectivity, and communicate status, time, and attendance information to a user of the expandable universal serial bus data terminal device;
a voice synthesis module or a voice playback module, located on the expandable universal serial bus data terminal device and interfaced with the microcontroller, to receive instructions from the microcontroller and provide prompting and status information to a user;
wherein the prompting and status information of the voice synthesis module is one or more of a controlled, synthesized voice message; and
wherein the prompting and status information of the voice playback module is one or more of a controlled, recorded voice message.

30. The data terminal device for time and attendance and data collection applications of claim 29, further comprising:
a memory module configured to store a digitized audio sequence for the voice playback module to play a recorded message and to store a code sequence of a plurality of words for the voice synthesis module to be synthesized and synthetically spoken;
a digital-to-analog converter to receive a data stream of information to be played in a recorded message or to be synthesized and synthetically spoken and to convert the data stream into an analog audio signal;
an audio transducer through which a message from the voice playback module or the voice synthesis module is broadcast and a user of the expandable universal serial bus data terminal device hears the message; and
an audio amplifier to amplify the analog audio signal for the audio transducer.

31. The data terminal device for time and attendance and data collection applications of claim 30, further comprising:
a potentiometer to control a gain of the audio amplifier, providing the user of the expandable universal serial bus data terminal device a means to directly control the volume of the audio amplifier and providing an operator at the host computer a means to directly control the volume of the audio amplifier.
